(19) United States
(12) Patent Application Publication
(10) Pub. No.: US 2008/0251602 A1
(43) Pub. Date: Oct. 16, 2008

(54) Wireless Irrigation and Trespasser Deterrent Control System (WITDCS)

(76) Inventors: CURTIS STEPHEN LEGGETT, Sooke (CA); Badi Dapilos Beattie, Brooks (CA)

Correspondence Address: J. GORDON THOMSON, P.O. BOX 8865, VICTORIA, BC, V8V 3Z1, CA

(21) Appl. No.: 11/869,177

(22) Filed: Oct. 9, 2007

Related U.S. Application Data
(60) Provisional application No. 60/850,312, filed on Oct. 10, 2006.

(51) Int. Cl. A01G 25/00

(52) U.S. Cl. 239/69

(57) ABSTRACT

A Wireless Irrigation and Trespasser Deterrent Control System used for controlling a remote irrigation system comprising a plurality of sprinklers connected by water pipes to one or more electric zone valves having wireless valve controllers. Included is a wireless system controller that communicates with the remote wireless valve controllers when a signal is received from a sensor such as a motion detector in order to turn the sprinklers on or off. Other sensors are possible such as soil moisture sensors and rain sensors. A handheld remote controller is also included.

### CROSS-REFERENCES

This application claims priority from U.S. Provisional Patent Application 60/850,312 filed by the inventors in the USPTO on Oct. 10, 2006 and entitled “Wireless Automatic Irrigation Control System (WAICS)”

### FIELD OF THE INVENTION

The present invention relates to a wireless automatic irrigation and deterrent control system and more particularly a programmable irrigation controller in wireless communication with a number of electric zone valves and remote sensors such as motion sensors capable of causing the programmable controller to activate a zone valve in response to the detection of motion.

### BACKGROUND OF THE INVENTION

Irrigation systems typically consist of a plurality of sprinklers, electric zone valves, and an electric controller. Individual sprinklers are fed by underground water pipes connected to a water supply source through electrically operated zone valves. The zone valves are typically AC powered solenoid valves which are hard wired directly to the controller. Control wire connects the controller to the zone valves usually buried underground.

Typical irrigation controllers are AC powered and are mounted on a wall near an AC outlet either indoors or outdoors. The controllers are typically of solid state design and allow the user to control the sequence of zones to be watered, the start time of each watering, the duration of each watering, and the interval between watering events.

A shortcoming of AC irrigation controllers is that they must be mounted within close proximity to an AC plug outlet while within range of the zone valves in order to successfully install conductor wires between the zone valves and controller. Sometimes running conductor wires is not possible due to obstructions or is not feasible due to long distances between the controller and the valves. This can force the controller to be mounted outdoors in a location that may not be aesthetically pleasing and could potentially be susceptible to theft or vandalism.

Another shortcoming is during repair to a system the serviceman must walk a great deal between the controller and the particular yard area of service in order to turn the system on and off.

Battery operated controllers exist that are typically powered by a single 9 volt battery and are located with the zone valves. DC latching solenoid valves are typically used instead of the AC solenoid valves; however, identical valve bodies are used for both methods. A shortcoming of these types of controllers is the controller is typically located near the valves below ground in a valve box which is hard to access for programming and manual operation.

A few other shortcomings of the battery operated systems are the inability to adapt remote sensors to the systems, and the systems are powered by a single 9 volt battery to operate. The battery power typically lasts a full watering season and the batteries are generally replaced at the start of every new season which results in extra maintenance costs. As well, if the batteries fall below a certain voltage the system does not function properly and the most common method of determining this is by dead foliage and lawn areas.

Residential and commercial properties that have irrigation systems installed typically take pride in the beauty of the lawn and flora, and perhaps the productivity of vegetables gardens, but the irrigation systems do not offer any animal or human security or deterrent benefits to the property.

The advantages of a wireless control system, using a battery to control the solenoid valve, have been recognized by others. For example, U.S. Pat. No. 4,626,984 to Unruh, U.S. Pat. No. 5,813,655 to Pinchott et al., and U.S. Pat. No. 4,962,522 to Marian, broadly suggests features of wireless control systems. None of these patents, however, suggest all of the features of the present invention, which are summarized below.

### SUMMARY OF THE INVENTION

A solution to the problems above has been devised. The present invention relates to a portable battery powered wireless irrigation controller capable of wirelessly transmitting control signals to the wireless controllers connected to the electric zone valves, and wirelessly receiving signals from remote control transmitters and remote sensors, in particular motion sensors.

The embodiment of the present invention eliminates the need for running wires between the controller system unit and field valve control devices or to field sensors. The wireless control system enables the transmission and reception of signals and commands via a wireless communication link rather than conductor wires and can circumvent physical obstacles, structures or distances that would otherwise prohibit or make impractical a hardwired implementation. The wireless control system is therefore a cost effective alternative to more expensive hardwire connection applications as detailed above.

The system includes a Wireless System Controller (WSC), one or more Wireless Valve Controllers (WVC), one or more Wireless Motion Detector modules, and has the ability to incorporate handheld on/off transmitters and other sensors such as moisture, rain, flow, and pressure to name a few. The WSC controller is designed with a transceiver to receive field signals from sensors, handheld transmitters and WVC's, and to transmit control signals to the WVC module. The WSC also includes a microcontroller and LCD and user input buttons, and a battery charging docking system. The WVC module is comprised of a transceiver and electronic circuitry that receives the control signals from the WSC, turns the appropriate zone valves on and off, and transmits the system status signals back to the WSC. A microcontroller is not required in the WVC; however, it could be added to provide additional functionality. Additionally, if bidirectional communication is not desired for system feedback from the WVC to the WSC, the WVC transceiver module could be substituted with a receiver module. The wireless motion detector module is comprised of an RF transmitter module and a motion detector system.

AC or DC electrical current can be used to power the WSC. One embodiment of the invention uses rechargeable batteries to power the WSC and includes a charging docking station to allow the batteries to be charged when the WSC is positioned in the charging docking station; however, the WSC can be removed from the docking station to have a completely portable control system. Super-capacitors could also be used instead of rechargeable batteries.

Typical AC powered controllers are not designed to be capable of supplying enough power to energize all the zone valves simultaneously. One example of the system utilizes DC latching solenoid valves that utilize less power and are powered by a low DC voltage source from 6 to 24V DC. As a result, all the zone valves can be operational at the same time. This functionality is desirable when large air compressors are used for winterization of the sprinkler lines in cold environments.

AC or DC electrical current can be used to power the WVC. One embodiment of the invention uses batteries to power the WVC. The WVC can be equipped with rechargeable batteries or large super capacitors and a battery charging module such as solar or a micro-hydro turbine generator charging system to provide a reliable power supply that addresses the problem of having to replace batteries every watering season. A small solar panel could be attached to the lid of the valve box or a turbine generator could be placed on a specific zone line or water main line. The turbine generator system is quite simple, as the water flows through the fitting which is equipped with a turbine and generator, a current is produced in proportion to the rate of flow of water through the fitting. The WVC could be equipped with a charging module to handle the proper charging of rechargeable batteries or super capacitors.

Another aspect of the present invention provides a failsafe method of ensuring the system is operating in the correct state of operation. The WSC transmits control signals to the WVC modules with unique ID's identifying the corresponding target device. When the signals are received and executed, the WVC transmits a system status signal back to the WSC that verifies the current state of the system. This provides a failsafe method of ensuring zone valves are not left in any unknown state such as remaining on for indefinite periods when the system is supposed to be in the off state.

Another embodiment of the present invention provides supplemental functionality to the underground sprinkler system, functionality that allows the system to be utilized not only for irrigation, but also as a trespasser and animal deterrent system. Wireless motion detector modules transmit control signals to the WSC controller when motion is detected in the monitoring region. Multiple motion detectors can be installed, and specific zone numbers and sensitivity may be user adjustable. When motion is detected a wireless control signal is transmitted to the controller and if the alert is warranted another wireless control signal is transmitted to the WVC for the appropriate zone valve to be controlled.

The WSC controller maintains a watering schedule and user input of the WSC is similar to modern controllers with the possible addition of selectable operation times for the motion detector system. Different start times and stop times of motion detection periods can be selected to enable and disable the motion detection system.

### BRIEF DESCRIPTION OF THE DRAWINGS

FIG. 1 is a view of a typical prior art irrigation control system.

FIG. 2 is a view of the Wireless Automatic Irrigation and Trespasser Deterrent Control System (WITDCS) of the present invention.

FIG. 3 is a flowchart of a method of the embodiment of FIG. 2.

FIG. 4 is a flowchart of a method of the embodiment of FIG. 2.

FIG. 5 is a perspective view of an embodiment of the Wireless Valve Controller installed with a micro-hydro turbine generator charging system.

### DESCRIPTION OF THE INVENTION

The following descriptions and the figures, to which it refers, are provided for the purpose of describing examples and specific embodiments of the invention only and are not intended to exhaustively describe all possible examples and embodiments of the invention. Many specific implementations of the following described WITDCS will be apparent to those of skill in the art.

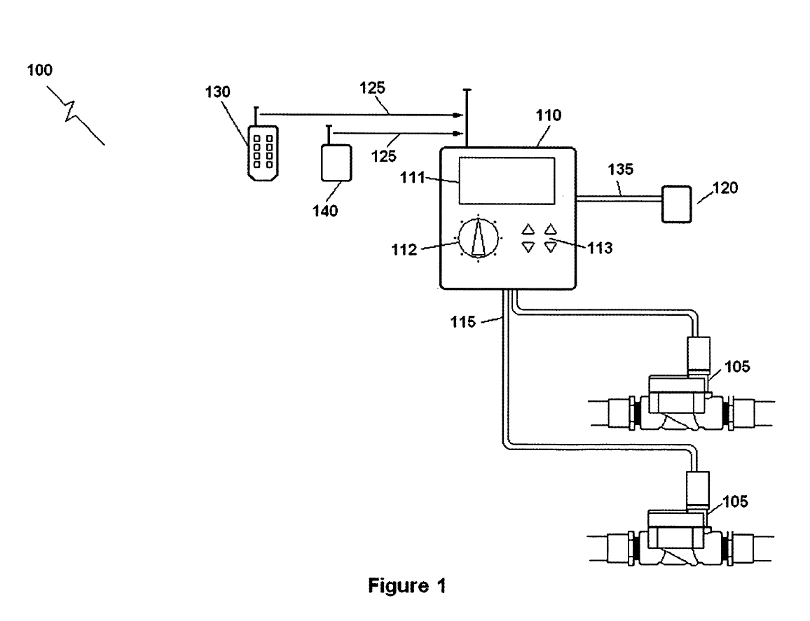

FIG. 1 shows a typical solid-state centralized irrigation system 100 of the prior art. The controller unit 110 is connected by means of conductor wires 115 and 135, to one or more electric zone valves 105, and/or field sensors 120, and is connected via a wireless communication link 125, to wireless field sensors 140, and/or a wireless On/Off remote control unit 130. The controller unit 110 contains an LCD 111 for viewing programming information, and different combinations of pushbuttons 113 and dials 112 for user entry of programming information.

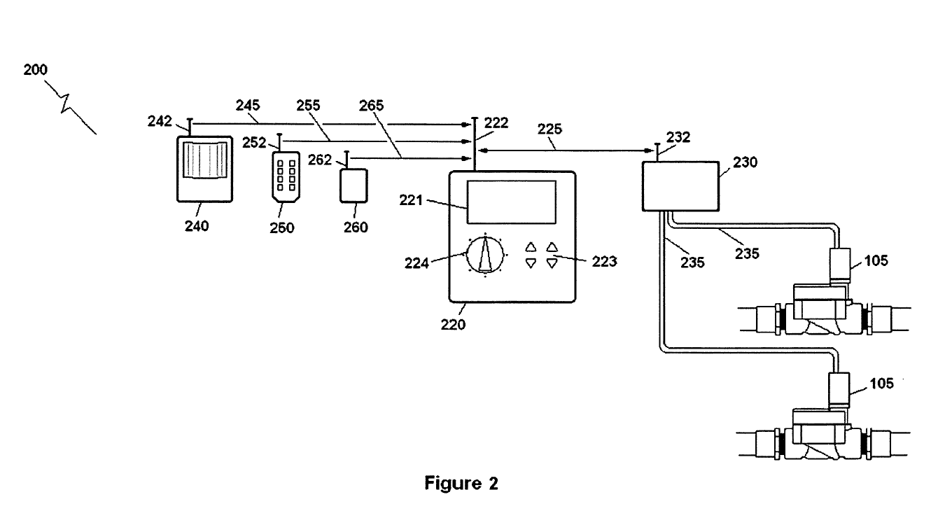

Referring now to FIG. 2, a view of an embodiment of the present invention is shown, an irrigation system employing WITDCS 200. FIG. 2 shows a completely wireless irrigation system which includes a WSC controller 220, a WVC module 230 connected to a number of electric zone valves 105 by wires 235, any number of Wireless Motion Detector modules 240, a Handheld Remote 250, and other wireless sensors 260.

In order for the WSC 220 to successfully transmit and receive multiple signals to and from each component in the system, each RF module of the system requires unique RF links which contain unique addressing or ID's. Additionally, each system could have unique addresses or ID's from neighboring systems which would allow multiple systems to be placed in close proximity to one another without causing any undesirable affects.

The WSC 220 is equipped with an RF transceiver and antenna 222 that is in wireless communication with the antenna and transceiver 232 of the WVC 230 via a unique RF wireless link 225. The WVC 230 is hardwired directly to the electric zone valves 105 and activates the different zone valves according to the received signals from the WSC 220. The WSC 220 RF transceiver and antenna 222 in turn receive system status signals from the antenna and transceiver 232 of the WVC 230 via a unique RF link 225 of periodic battery levels and as zone valves 105 are opened and closed.

The WSC 220 RF transceiver and antenna 222 receive wireless signals from the Wireless Motion Detector module antenna and transmitter 242 via a unique RF link 245, the Handheld Remote antenna and transmitter 252 via a unique RF link 255, and other wireless sensors antenna and transmitters 262 via a unique RF link 265.

The WSC 220 contains an LCD 221 for viewing programming information, and different combinations of pushbuttons 223 and dials 224 for user entry of programming information

In the present example the WITDCS incorporates single modules of the following: WVC 230, Wireless Motion Detector module 240, Handheld Remote 250, and other sensors 260; however, practical systems could incorporate as many or as few of each of the modules as desired.

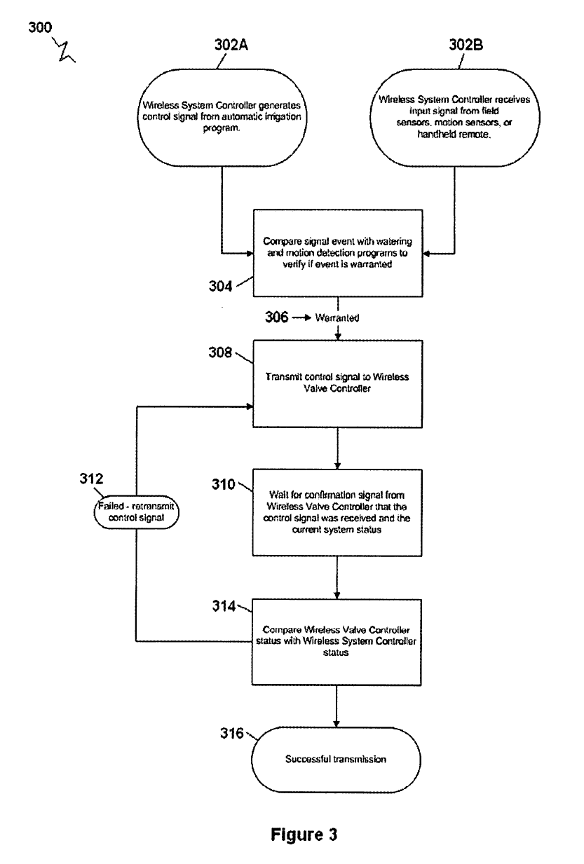

FIG. 3 is a flowchart 300 of a method of operation of the embodiment WSC 220 of FIG. 2 that shows a failsafe method of ensuring control signals of the WSC 220 are transmitted correctly to the WVC 230. A digital signal event is either generated by the internal microcontroller watering program 302a of the WSC 220 or received 302b by the antenna and transceiver 222 of the WSC 220 from the Wireless Motion Detector modules 240, a Handheld Remote 250, or other wireless sensors 260. The signal event is compared 304 with the user defined program of the WSC 220 consisting of an automatic watering program and an automatic trespasser deterrent program. If the event is warranted 306, a control signal is transmitted 308 from the WSC 220 RF transceiver and antenna 222 to the antenna and transceiver 232 of the WVC 230 via a unique RF wireless link 225. The WSC 220 then waits to receive a confirmation signal 310 consisting of the system state from the antenna and transceiver 232 of the WVC 230. The input system status signal is then compared 312 to the internal system state of the WSC 220. If the states do not match 314, the WSC 220 transmits another control signal to the WVC 230 until the WSC 220 successfully 316 receives a matched system status signal from the WVC 230. The failsafe method of ensuring the control signal of the WSC 220 is received and interpreted correctly by the WVC 230 is completed when the states of the WSC 220 and WVC 230 match.

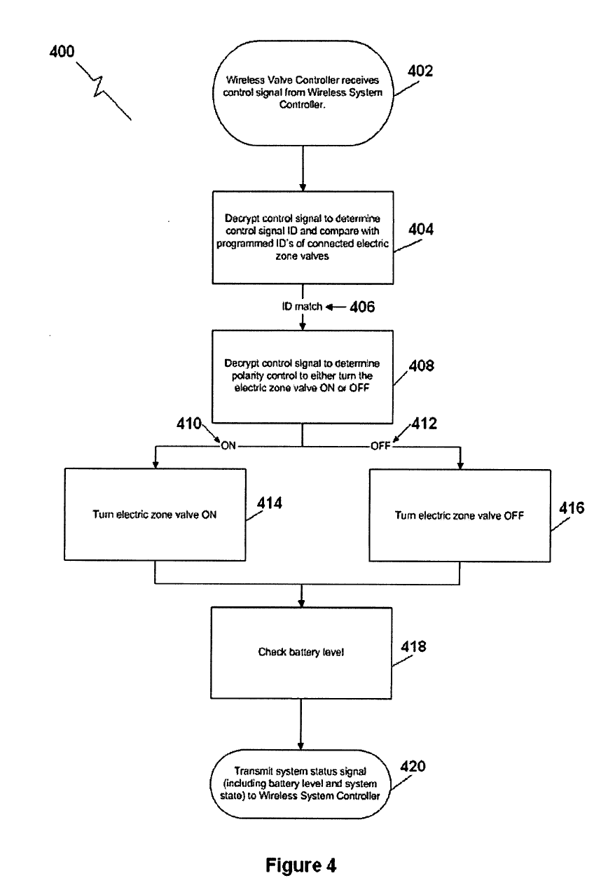

FIG. 4 is a flowchart 400 of a method of operation of the embodiment WVC 230 of FIG. 2 that shows a failsafe method of ensuring control signals of the WSC 220 are received and interpreted correctly by the WVC 230. A digital control signal is received 402 by the antenna and transceiver 232 of the WVC 230 and is decrypted 404 to determine if the control signal ID matches 406 the ID of a connected electric zone valve 105. If the ID's are a match, the control signal is further decrypted 408 to determine the polarity control to turn the electric zone valve 105 ON 410 or OFF 412. The electronic circuitry of the WVC 230 generates the electrical signal to turn ON 414 or OFF 416 the electric zone valve 105 with the matching ID and monitors the voltage level 418 of the connected battery. The antenna and transceiver 232 of the WVC 230 transmit a system status 420 signal consisting of the system state and battery voltage level to the antenna and transceiver 222 of the WSC 220.

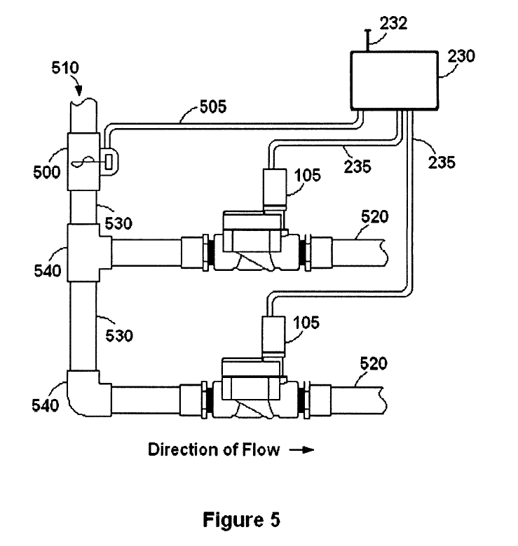

FIG. 5 is a view of an embodiment of the Wireless Valve Controller installed with a micro-hydro turbine generator charging system 500. The turbine generator charging system 500 is attached inline to the piping 530 and fittings 540 of the irrigation system preferably to water main 510 upstream of the electric zone valves 105. The electrical wire leads 505 of the turbine charging system 500 connect to the battery terminals of the WVC 230. As water flows through the irrigation system piping 520 electrical current is generated by the turbine generator 500 that recharges the batteries or super-capacitors of the WVC 230.

Although this description has much specificity, these should not be construed as limiting the scope of the invention but as merely providing illustrations of some of the presently preferred embodiments of this invention. Thus the scope of the invention should be determined by the appended claims and their legal equivalents, rather than by the examples given.

What is claimed is:

1. A Wireless Irrigation and Trespasser Deterrent Control System for controlling an irrigation system comprising a plurality of sprinklers connected by water pipes to at least one electric zone valve for controlling the flow of water to said plurality of sprinklers, said control system comprising:
a. a wireless system controller adapted to receive a first signal from at least one remote sensor and transmit a second signal in response to said first signal to;
b. at least one wireless valve control module operatively connected to said at least one electric zone valve for operating the at least one electric zone valve between an open position and a closed position, wherein said second signal determines whether the at least one electric zone valve is in said open or said closed position.

2. The control system of claim 1 wherein said wireless system controller further comprises a programmable controller and wherein said second signal is in response to a command from said programmable controller.

3. The control system of claim 2 wherein said at least one remote sensor is an environmental monitoring sensor adapted to sense a specific environmental condition.

4. The control system of claim 3 wherein a plurality of said environmental monitoring sensors are in wireless communication with the wireless system controller and wherein each of the plurality of environmental monitoring sensors transmits a respective first signal having a unique identification indicative of said specific environmental condition being monitored for receipt and processing by the wireless system controller.

5. The control system of claim 4 wherein said respective first signal is encrypted for decryption by the wireless system controller and further wherein the second signal is encrypted for decryption by the wireless valve control module.

6. The control system of claim 5 wherein the respective first signal and the second signal are radio frequency signals.

7. The control system of claim 6 wherein the wireless system controller is powered by on-board batteries.

8. The control system of claim 7 wherein the wireless system controller is portable.

9. The system of claim 8 wherein the wireless system controller can be placed in a recharging docking station while not in use to allow said on-board batteries to recharge.

10. The control system of claim 1 wherein the wireless valve controller is powered by on-board batteries.

11. The system of claim 10 wherein the wireless valve controller on-board batteries are recharged by solar cells.

12. The system of claim 10 further including a turbine generator for placement upstream of the at least one electric zone valve and electrically connected to the wireless valve controller so that when water flows through the at least one electric zone valve power is generated to recharge the on-board batteries.

13. A Wireless Irrigation and Trespasser Deterrent Control System for controlling an irrigation system comprising a plurality of sprinklers connected by water pipes to at least one electric zone valve for controlling the flow of water to said plurality of sprinklers, said control system comprising:
a. a wireless system controller adapted to receive a first signal from at least one remote sensor and transmit a second signal in response to said first signal to;
b. at least one wireless valve control module operatively connected to said at least one electric zone valve for operating the at least one electric zone valve between an open position and a closed position, wherein said second signal commands a desired state of the electric zone valve;
c. a programmable controller adapted to store system operating commands in response to the first signal;
d. wherein said at least one wireless valve control module transmits a third signal to the wireless system controller, said third signal indicative of the actual state of the electric zone valve;
e. so that upon receipt of the third signal from the at least one wireless control module, said programmable controller compares the actual state of the electric zone valve with said desired state in order to confirm the correct operation of the system.

14. The system of claim 13 wherein the desired state is not equal to the actual state resulting in the second signal being retransmitted a predetermined number of times until the desired state is obtained.

15. The system of claim 14 wherein retransmission of said predetermined number of second signals fails to achieve the desired state resulting in an error signal display on the wireless system controller.

16. The system as claimed in claim 15 wherein the third signal transmits the condition of the battery in the wireless valve controller.

17. The system of claim 15 wherein at least one remote sensor is a motion detector comprising a DC powered RF transmitter for generating a first signal in response to detected motion and a daylight sensing circuit adapted to vary the sensitivity of the motion detector from night to day and wherein the programmable controller is adapted to process said first signal during predetermined hours, said daylight sensing circuit adapted to restrict the operation said DC powered RF transmitter to said predetermined hours in order to reduce power consumed by the RF transmitter.
